(19) United States
(12) Patent Application Publication
(10) Pub. No.: US 2025/0324458 A1
(43) Pub. Date: Oct. 16, 2025

(54) RANDOM ACCESS CHANNEL PROCEDURE SUCCESS WITHIN A TELECOMMUNICATIONS NETWORK

(71) Applicant: DISH Wireless L.L.C., Englewood, CO (US)

(72) Inventors: Karupaiah Rajendran, Sachse, TX (US); Norberto Amaya Gonzalez, San Diego, CA (US)

(21) Appl. No.: 18/635,511

(22) Filed: Apr. 15, 2024

(51) Int. Cl. H04W 74/0833; H04L 1/00; H04W 72/1268

(52) U.S. Cl. CPC H04W 74/0833; H04L 1/0003; H04W 72/1268

(57) ABSTRACT

Technologies for improving random access channel (RACH) procedure success within a telecommunications network are described. One method includes receiving counter data indicative of success of a RACH message sent, in accordance with a set of parameters defining the RACH message, from a first component of a telecommunications network to a second component of the telecommunications network, determining, based on the counter data, whether to modify at least one parameter of the set of parameters, in response to determining to modify the at least one parameter based on the counter data, modifying the at least one parameter to obtain a modified set of parameters, and causing the message to be sent, in accordance with the modified set of parameters, from the first component to the second component.

### BACKGROUND

A telecommunication network, such as a cellular network, can use a Random Access Channel (RACH) procedure to enable user equipment (UE) to initiate communication with a radio access network (RAN) of the telecommunication network. In particular, the RACH procedure can enable the UE to initiate communication with a base station of the RAN. In a fifth generation (5G) wireless network (referred to as a “5G network”), the base station is referred to a Next Generation Node B, a “gNodeB,” or a “gNB.” The RACH procedure can be used by UEs to establish their initial connection with a base station when they have data to send or when initially turning on within the network coverage area. The RACH procedure can also be used for resource requests. The RACH procedure allows a UE to request resources for uplink data transmission, particularly when the UE has not been active for some time and does not have scheduled resources. For UEs at the edge of coverage areas or in challenging environments, 5G networks can include features to enhance RACH procedure performance, such as increased preamble power and repetition techniques.

The RACH procedure in 5G networks has evolved from its counterpart in long-term evolution (LTE) networks (also referred to as 4G networks). While the basic principles remain similar, 5G RACH procedures have been optimized for greater efficiency, lower latency, and to support a massive number of devices, reflecting the diverse and demanding requirements of the 5G era. This includes enhancements for better handling of contention, improved procedures for devices with limited power or in poor coverage, and the flexibility to support a wide variety of use cases, including massive machine-type communications (mMTC) and ultra-reliable low-latency communications (URLLC). 5G UE may communicate over both a lower frequency Sub-6 GHz band between 410 MHz and 7125 MHz and a higher frequency mmWave band between 24.25 GHz and 52.6 GHz. The design of RACH procedures in 5G supports a wide range of use cases, from IoT devices with sporadic data transmission needs to high-performance applications requiring rapid access and low latency.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of an example telecommunications network, according to some embodiments.

FIG. 2 is a table illustrating an example set of random access channel (RACH) procedure counters, according to some embodiments.

FIGS. 3A-3C are tables illustrating example modifications of random access channel (RACH) procedure parameters, according to some embodiments.

FIGS. 4-5 are flow diagrams of example methods for improving random access channel (RACH) procedure success within a telecommunications network, according to some embodiments.

FIG. 6 depicts a 5G network including a radio access network (RAN) and a core network, according to some embodiments.

FIG. 7 depicts a radio access network and a core network for providing a communications channel (or channel) between user equipment and data network, according to some embodiments.

FIGS. 8A-8B depict a radio access network, according to some embodiments.

### DETAILED DESCRIPTION

Technologies for improving random access channel (RACH) success within a telecommunications network, such as a cellular network (e.g., 5G wireless network, 6G wireless network), are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular embodiments may vary from these exemplary details and still be contemplated to be within the scope of the present disclosure.

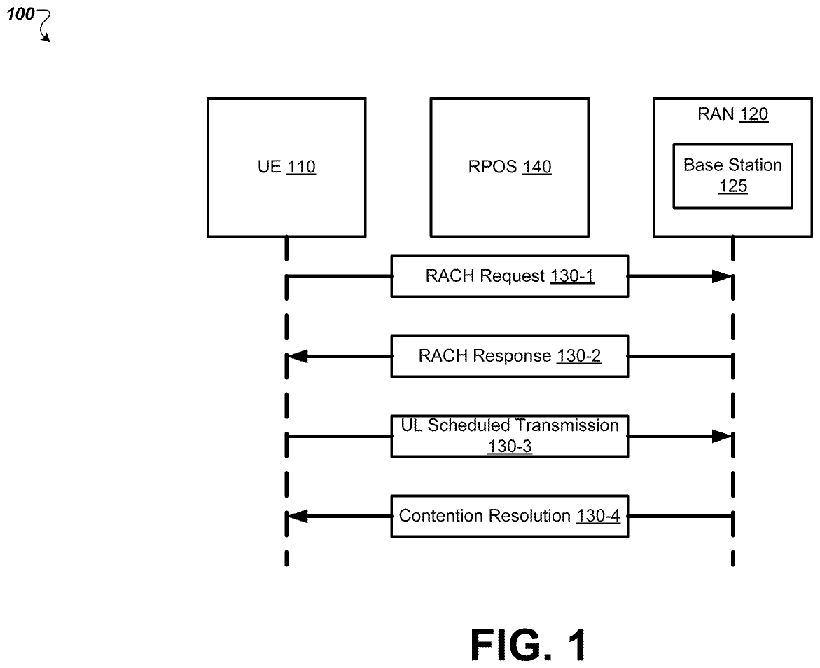

A RACH procedure can fail for various reasons. For example, a message sent by a UE to a RAN (e.g., the base station) of a telecommunications network during a RACH procedure, or vice versa, may not be received or processed by the base station (or the UE). To maximize success (or minimize failure) of the RACH procedure, each message during the RACH procedure can be defined by a set of parameters each having a maximum value supported by the system. Further details regarding messages and parameters will be described below with reference to FIG. 1.

However, maximizing values of each parameter of a set of parameters can contribute to an unnecessary and inefficient use of resources within the telecommunications network. For example, this can limit the number of UEs that are supported by the telecommunications network.

Aspects and embodiments of the present disclosure address the above and other deficiencies by improving RACH procedure success rates (or decrease RACH procedure failure rats) in a telecommunications network, which will now be described in further detail below with reference to FIG. 1. Accordingly, embodiments described herein can improve ability of UEs to connect with RANs within telecommunications network.

FIG. 1 is a diagram of a system 100 including a telecommunications network, according to some embodiments. As shown in FIG. 1, the system 100 can include user equipment (UE) 110 and a radio access network (RAN) 120. The UE 110 can include an electronic device with wireless connectivity or cellular communication capability, such as a mobile phone or handheld computing device. The UE 110 can include any suitable computing device that can connect to the RAN 120 via a wireless connection. For example, the UE 110 can include a mobile computing device. As another example, the UE 110 can include a non-mobile computing device. Examples of suitable computing devices that the UE 110 can include are laptop computers, desktop computers, Internet-of-Things (IoT) devices, and/or any other computing devices that include a wireless communications interface to communicate with the RAN 120. The UE 110 can be one of a plurality of UEs (not depicted) that are in communication with the RAN 120. The RAN 120 can implement radio access technology that can be used to enable the connection of the UE 110 to a core network of the telecommunications network (not shown in FIG. 1). As shown in FIG. 1, the RAN 120 can include a base station 125 (e.g., cell site or cell tower). The base station 125 is an element of the telecommunications network that is responsible for the transmission and reception of radio signals in one or more cells to or from UE 110. The RAN 120 can include multiple base stations that each cover a respective coverage area.

In some embodiments, the base station 125 includes multiple base station components (e.g., antenna arrays), where each base station component of the base station 125 provides coverage over a respective sector of the coverage area covered by the base station 125. For example, the base station 125 can include three base station components (e.g., alpha, beta and gamma), where each base station component provides coverage over a respective 120° sector of the 360° coverage area covered by the base station 125.

In some embodiments, the telecommunications network of the system 100 is a 5G network. For example, the UE 110 can include a 5G smartphone or a 5G cellular device that connects to the RAN 120 via a wireless connection, and the RAN 120 can include a new-generation radio access network (NG-RAN) that uses the 5G new radio interface (NR), and the base station 125 is a 5G base station (e.g., gNB).

The UE 110 can gain initial access to the telecommunications network by communicating with the RAN 120 through a random access channel (RACH). More specifically, the UE 110 may seek initial access when the UE 110 is not synchronized with the RAN 120 or when the telecommunications network does not have prior UE scheduling information for the UE 110. For example, initial access can be an absolute first access for the UE 110, or a relative first access for UE 110 after a period of inactivity.

Various types of RACH procedure trigger events can cause a RACH procedure to be initiated between the UE 110 and the RAN 120. One type of RACH procedure trigger event is a connection request. Another type of RACH procedure trigger event is a radio link failure. Another type of RACH procedure trigger event is a handover event. Another type of RACH procedure trigger event is UL data arrival (e.g., the UE 110 needs access to the RAN 120 to obtain resources for uplink transmission).

In some embodiments, a RACH procedure is a contention-based RACH procedure. A contention-based RACH procedure can be used in scenarios in which the RAN 120 does not have prior knowledge about the UE 110 attempting to gain initial access. For example, to implement a contention-based RACH procedure, the UE 110 can send a RACH request message (MSG1) 130-1 to the base station 125. The RACH request message 130-1 includes a random access preamble (“preamble”). More specifically, the UE 110 can select the preamble from a set of (predefined) preambles, along with a random sequence number of the preamble, and then send the preamble to the base station 125 via the RACH request message 130-1.

In response to receiving the RACH request message 130-1, the base station 125 can send a RACH response message (MSG2) 130-2 to the UE 110. The RACH response message 130-2 can include, among other things, an initial uplink (UL) grant for the UE 110.

The base station 125 can handle multiple UEs of the system 100, including the UE 110. The system 100 may need to ensure that the UL signal from every UE of the system 100 is aligned with a common receiver timer of the system 100. To do so, the UE 110 can send an uplink (UL) scheduled transmission message (MSG3) 130-3 to the base station 125. More specifically, the UE 110 can use the initial UL grant received from the base station 125 to send the UL scheduled transmission message 130-3 on a physical UL shared channel. The UL scheduled transmission message 130-3 can further specify a type of event that triggered the RACH procedure. Examples of types of events can include connection request, radio link failure, a handover event, UL data arrival, etc.

After processing the UL scheduled transmission message 130-3, the base station 125 can send a contention resolution message (MSG4) 130-4 to the UE 110 if there is no contention between the UE 110 and at least one other UE of the system 100. Contention refers to a situation in which at least two UEs send the same preamble to the base station 125 at approximately the same time. For example, the UE 110 and another UE can send the same preamble at approximately the same time to respective base station components of the base station 125. One way to avoid contention in this scenario is by the base station 125 assigning each preamble, within the same time slot of a time spectrum corresponding to a time domain, to a respective set of resource blocks (RBs) of a frequency spectrum corresponding to a frequency domain. Another way to avoid contention in this scenario is by the base station 125 assigning each preamble to a set of RBs within a respective time slot.

More specifically, each RB corresponds to a set of consecutive subcarriers in the frequency domain. An RB can include a set of resource elements (REs). Each RE is uniquely identifiable by a subcarrier index (k) corresponding to a subcarrier in the frequency domain and a symbol index (l) corresponding to a symbol in the time domain (e.g., orthogonal frequency division multiplexing (OFDM) symbol). That is, each RE of an RB can be uniquely identifiable by the coordinate (k,l), and the number of REs of an RB can be defined as the product of the total number of subcarriers corresponding to the RB (e.g., 12) and the total number of symbols. The number of resource blocks allocated to a UE and/or a transmission can be used to determine the available bandwidth for the transmission.

The contention resolution message 130-4 can include an identifier of the UE 110, which provides confirmation to the UE 110 that the base station 125 has correctly identified the UE 110 and that contention has been resolved. At this step, the base station 125 can provide the UE 110 with a radio network temporary identifier (RAN TI). If the UE 110 does not receive a contention resolution message within a certain amount of time from sending the UL scheduled transmission message 130-3, then the UE 110 knows that there is unresolved contention, and will proceed to re-attempt to gain initial access through the RACH procedure.

In some embodiments, a RACH procedure is a contention-free RACH procedure. A contention-free RACH procedure is a RACH procedure in which a contention resolution message is not sent by the base station 125 to the UE 110. In the contention-free RACH procedure, the base station 125 can assign each UE of the system 100 (e.g., UE 110) a respective unique preamble to avoid contention. Each UE can then use its respective preamble to initiate the RACH procedure. A contention-free RACH procedure can be used in scenarios in which the RAN 120 has prior knowledge about the UE 110 attempting to gain initial access.

A RACH procedure can be controlled by RACH procedure parameters (“parameters”). For example, a RACH procedure parameter can be a base station parameter. One example of a RACH procedure parameter is transport block (TB) size. TB size refers to the size of data blocks (e.g., bits or bytes) that are transported between the UE 110 and the base station 125.

Another example of a RACH procedure parameter is a modulation and coding scheme (MCS) value. MCS is a technique used to modulate data bits and apply error-correction codes before data transmission. The MCS value determines how many bits can be transmitted per symbol and how robust the transmission is to channel impairments. Higher MCS values can indicate higher data rates, but may with reduced reliability in poor channel conditions.

Another example of a RACH procedure parameter is a number of resource blocks.

Another example of a RACH procedure parameter is a radio access radio network temporary identifier (RA RNTI) aggregation level (AL) (RA RNTI AL). An RA RNTI is a unique identifier assigned to the UE during the RACH procedure to identify and establish communication with the base station. More specifically, an RA RNTI is a temporary identifier assigned by the RAN 120 to the UE 110 during the initial steps of establishing or re-establishing communication with the RAN 120. It helps in correlating the random access attempts from the UE 110 with the responses from the RAN 120.

Generally, an AL can specify the number of control channel elements (CCEs) that are allocated to a physical downlink control channel (PDCCH) to send downlink control information (DCI) to the UE 110. A CCE can include six resource element groups (REGs), where each REG corresponds to one RB during one symbol. The AL can be determined based on the distance between the UE 110 and the base station 125. The AL can vary depending on the capabilities of the telecommunications network (e.g., the RAN 120) and/or the UE 110. In some embodiments, the AL ranges from 1 to 8. For example, an AL of 1 (AL1) can specify that 1 CCE should be allocated to the PDCCH, and AL of 2 (AL4) can specify that 2 CCEs should be allocated to the PDCCH, an AL of 4 (AL4) can specify that 4 CCEs should be allocated to the PDCCH, and an AL of 8 (AL2) can specify that 8 CCEs should be allocated to the PDCCH.

Another example of a RACH procedure parameter is a physical RACH (PRACH) configuration. The PRACH refers to a channel used by a UE to initiate the RACH procedure. The PRACH configuration can include a set of parameters configuring the PRACH. For example, the PRACH configuration can specify at least one time slot in the time domain, at least one message frequency start in the frequency domain, etc. Modifying the PRACH configuration can include modifying at least one of the at least one slot, the at least one message frequency start, etc.

Another example of a RACH procedure parameter is a number of symbols. Data can be transmitted in the telecommunications network in the form of symbols. The number of symbols can vary depending on factors such as the modulation scheme, coding rate, and other parameters. The number of symbols can be used to determine the duration of a transmission and the amount of data that can be sent within a given timeframe.

Another example of a RACH procedure parameter is a grant size. A grant refers to the allocation of resources by the base station to the UE for transmitting data. A grant size refers to the amount of resources (frequency bandwidth, time duration, etc.) allocated to the UE for data transmission. This allocation can be performed dynamically based on factors like UE channel conditions, quality of service requirements, network congestion, etc.

Another example of a RACH procedure parameter is a physical uplink shared channel (PUSCH) resource block allocation. A PUSCH is a channel used by a UE to transmit data to a base station. PUSCH resource block allocation refers to an allocation of resource blocks in the uplink frequency spectrum for the transmission of data by the UE. This allocation can be determined by the base station and can vary dynamically based on factors such as UE channel conditions, scheduling algorithms, quality of service requirements, etc.

Each message sent during the RACH procedure can be defined in accordance with a respective set of parameters. For example, the RACH request message (MSG1) 130-1 can be defined by a set of parameters including frequency start, PRACH location, PRACH transmit power, and PRACH configuration. As another example, the RACH response message (MSG2) 130-2 can be defined by a set of parameters including TB size, MCS value, RA RNTI AL, and PRACH configuration. As yet another example, the UL scheduled transmission message (MSG3) 130-3 can be defined by a set of parameters including TB size, MCS value, number of resource blocks, number of symbols, grant size, and PUSCH resource block allocation. As yet another example, the contention resolution message (MSG4) 130-4 can be defined by a set of parameters including TB size, MCS, number of resource blocks, and AL.

The system 100 can further include a RACH procedure optimization system (RPOS) 140 for improving RACH procedure success rates (or decrease RACH procedure failure rats) in the system 100. In some embodiments, the RPOS 140 is a component of the RAN 120. In some embodiments, the RPOS 140 is a standalone component of the system 100 that is in communication with the RAN 120. The RPOS 140 can include a memory and a processing device operatively coupled with the memory.

In some embodiments, the RPOS 140 maintains one or more sets of RACH procedure counters for monitoring RACH procedure performance (e.g., success or failure). In some embodiments, the RPOS 140 maintains multiple sets of RACH procedure counters, where each set of RACH procedure counters is defined for a particular message sent during a RACH procedure. For example, a first set of RACH procedure counters can be maintained for the RACH request message (MSG1) 130-1, a second set of RACH procedure counters can be maintained for the RACH response message (MSG2) 130-2, a third set of RACH procedure counters can be maintained for the UL scheduled transmission message (MSG3) 130-3, and a fourth set of RACH procedure counters can be maintained for the contention resolution message (MSG4) 130-4.

For example, a set of RACH procedure counters can include, for each type of RACH procedure trigger event, a respective RACH procedure trigger count. A RACH procedure trigger count identifies the total number of times that the RACH procedure has been initiated for the respective type of RACH procedure trigger event. In some embodiments, the set of RACH procedure counters includes a total RACH procedure trigger count defined as the sum of each RACH procedure trigger count.

In some embodiments, the set of RACH procedure counters further includes, for each type of RACH procedure trigger event, a respective RACH procedure success count. A RACH procedure success count identifies the total number of times that the RACH procedure was successful for the respective type of RACH procedure trigger event. Accordingly, for each type of RACH procedure trigger event, a RACH procedure success metric (e.g., RACH procedure success rate) for the type of RACH procedure trigger event can be determined from the RACH procedure success count for the type of RACH procedure trigger event and the RACH procedure trigger count for the type of RACH procedure trigger event.

In some embodiments, the set of RACH procedure counters further includes, for each type of RACH procedure trigger event, a respective RACH procedure failure count. A RACH procedure failure count identifies the total number of times that the RACH procedure has failed for the respective type of RACH procedure trigger event. Accordingly, for each type of RACH procedure trigger event, a RACH procedure failure metric (e.g., RACH procedure failure rate) for the RACH procedure trigger event can be determined from the RACH procedure failure count for the type of RACH procedure trigger event and the RACH procedure trigger count for the type of RACH procedure trigger event.

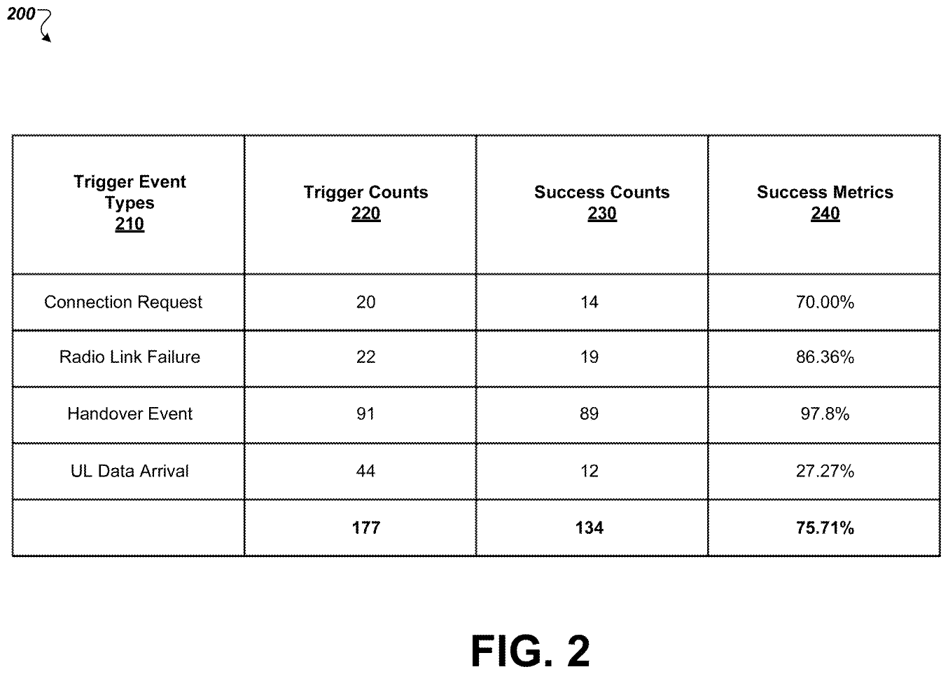

A failure of a message sent during a RACH procedure (for a type of RACH procedure trigger event) can be identified if the amount of time that elapses from when the message was sent without a response exceeds a threshold amount of time. For example, if the UE 110 sends the RACH request message (MSG1) 130-1 to the UE 110 and the UE 110 does not receive the RACH response message (MSG2) 130-2 within the threshold amount of time, then it can be deduced that there was a RACH procedure failure with respect to the RACH request message 130-1. Similar deductions can be made with respect to other messages sent during the RACH procedure. An illustrative example of a set of RACH procedure counters will now be described below with reference to FIG. 2.

FIG. 2 is a table 200 illustrating a set of RACH procedure counters corresponding to a RACH procedure performed between a UE (e.g., the UE 110 of FIG. 1) and a RAN (e.g., the RAN 120 of FIG. 1), according to some embodiments. In some embodiments, the set of RACH procedure counters is maintained by a RACH procedure optimization system (e.g., the RPOS 140 of FIG. 1). In some embodiments, the set of RACH procedure counters corresponds to a particular message of a RACH procedure (e.g., MSG1, MSG2, MSG3 or MSG4). In some embodiments, the telecommunications network includes a 5G network. For example, the RACH procedure can be performed in the context of a Voice over New Radio (VoNR) embodiment to enable a voice communication service over the 5G network. VoNR can also be referred to as Voice over 5G (Vo5G).

As shown in FIG. 2, the table 200 includes a column 210 identifying types of RACH procedure trigger events (“trigger event types”) to trigger a RACH procedure. For example, the trigger events can include a connection request, a radio link failure, a handover event, and UL data arrival.

The table 200 further includes a column 220 identifying RACH procedure trigger counts (“trigger counts”) for respective trigger event types, a column 230 identifying RACH procedure success counts (“success counts”) for respective trigger event types, and a column 240 identifying RACH procedure success metrics (“success metrics”) for respective trigger event types. In this example, success metrics (e.g., success rates) are depicted as percentages. However, this should not be considered limiting. Illustratively, if the set of RACH procedure counters corresponds to MSG2, then the column 220 specifies the MSG2 trigger count during RACH procedures triggered by the respective trigger event types, the column 230 specifies the corresponding MSG2 success count, and the column 240 specifies the corresponding MSG2 success metric.

As shown in the table 200, for the connection request trigger event type, the column 220 indicates a trigger count of 20, the column 230 indicates a success count of 14, and the column 240 a success rate of 70%.

As further shown in the table 200, for the radio link failure trigger event type, the column 220 indicates a trigger count of 22, the column 230 indicates a success count of 19, and the column 240 indicates a success metric of 86.36%.

As further shown in the table 200, for the handover event trigger event type, the column 220 indicates a trigger count of 91, the column 230 indicates a RA success count of 89, and the column 240 indicates a success metric of 97.80%.

As further shown in the table 200, for the UL data arrival type trigger event type, the column 220 indicates a trigger count of 44, the column 220 indicates a success count of 12, and the column 220 indicates a success metric of 27.27%.

The column 220 further indicates a total trigger count across each trigger event type of 177. The column 230 further indicates a total success count across each trigger event type of 134. The column 240 further indicates a total success metric across each trigger event type of 75.71%.

Alternatively, instead of success counts and success metrics, the table 200 can include a RACH procedure failure count (“failure count”) and a RACH procedure failure metric (“failure metric”) for each trigger event type. Illustratively, for the connection request trigger event type show in the table 200, the failure count can be 6 (20 trigger counts minus 14 success counts), and the failure metric can be 30.00% (100% minus 70.00%).

As described above with reference to FIGS. 1-2, a RACH procedure triggered by a trigger event may not be successful. Additionally, some RACH procedure embodiments have lower success metrics (or higher failure rates) than others. For example, in FIG. 2, the UL data arrival trigger event type had a success metric of 27.27%, which can correspond to an unacceptable level of RACH procedure failure. A high frequency of RACH procedure failure can impact the ability of a UE to initialize connection to a RAN of a telecommunications network.

Referring back to FIG. 1, the RPOS 140 can improve a RACH procedure success by modifying (e.g., tweaking) RACH procedure parameters used to control the RACH procedure. For example, a RACH procedure parameter can be a configurable parameter defining a message sent during the RACH procedure (e.g., a base station parameter maintained by the base station 125). As discussed above, each message sent during a RACH procedure can be defined by a respective set of parameters. The RPOS 140 can cause at least one parameter of at least one set of parameters to be selectively modified to increase the success rate of the RACH procedure to improve the success of the RACH procedure.

In some embodiments, the RPOS 140 determines whether to modify the at least one parameter based on a trigger count, and causes the at least one parameter to be modified in response to determining to modify the at least one parameter. For example, the trigger count can correspond to a trigger event type, and the at least one parameter can be modified for the RACH procedure triggered by the trigger event type.

In some embodiments, determining whether to modify the at least parameter based on the trigger count includes determining whether success of the RACH procedure determined from the trigger count fails to satisfy a threshold condition, and causes at least one parameter of the set of RACH procedure parameters to be modified in response to determining that the success of the RACH procedure determined from the trigger count fails to satisfy the threshold condition.

In some embodiments, determining whether success of a RACH procedure determined from a trigger count fails to satisfy a threshold condition includes determining whether a success metric is less than or equal to a threshold success metric (or a failure metric is greater than or equal to a threshold failure metric). In response to determining that the success metric is less than or equal to the threshold success metric (or that the failure metric is greater than or equal to the threshold failure metric), the RPOS 140 can modify at least one parameter of the set of RACH procedure parameters.

In some embodiments, modifying at least one parameter of a set of parameters includes modifying at least one parameter of a set of parameters defining the RACH response message (MSG1) 130-1. The RPOS 140 can cause the UE 110 to modify the at least one parameter of the set of parameters defining the RACH response message (MSG1) 130-1 (e.g., using a radio resource control (RRC) protocol). For example, modifying the at least one parameter defining the RACH response message (MSG1) 130-2 can include modifying at least one of: frequency start, PRACH location, PRACH transmit power, or PRACH configuration.

In some embodiments, modifying at least one parameter of a set of parameters includes modifying at least one parameter of a set of parameters defining the RACH response message (MSG2) 130-2. For example, modifying the at least one parameter defining the RACH response message (MSG2) 130-2 can include modifying at least one of: TB size, MCS value, RA RNTI AL, or a PRACH configuration.

In some embodiments, modifying at least one parameter of a set of parameters includes modifying at least one parameter of a set of parameters defining the UL scheduled transmission message (MSG3) 130-3. The RPOS 140 can cause the UE 110 to modify the at least one parameter of the set of parameters defining the UL scheduled transmission message (MSG3) 130-3 (e.g., using an RRC protocol). For example, modifying the at least one parameter defining the UL scheduled transmission message (MSG3) 130-3 can include modifying at least one of: TB size, an MCS value, a number of RBs, a number of symbols, a grant size, or a PUSCH RB allocation. The RPOS 140 can cause the UE 110 to modify the at least one parameter of the set of parameters defining the UL scheduled transmission message (MSG3) 130-1.

In some embodiments, modifying at least one parameter of a set of parameters includes modifying at least one parameter of a set of parameters defining the contention resolution message (MSG4) 130-4. For example, modifying the at least one parameter defining the contention resolution message (MSG4) 130-4 can include modifying at least one of TB size, an MCS value, or a number of RBs, or an AL.

For a set of parameters defining a message, the parameter(s) of the set of parameters to be modified can be determined based on the trigger event type that triggered the RACH procedure (e.g., connection request, radio link failure, handover event, or UL data arrival). More specifically, a failure of a RACH procedure triggered by a first trigger event type can cause a modification to a first combination of parameters of a set of parameters, and a failure of a RACH procedure triggered by a second trigger event type can cause a modification to a second combination of parameters of the set of parameters, different from the first combination of parameters.

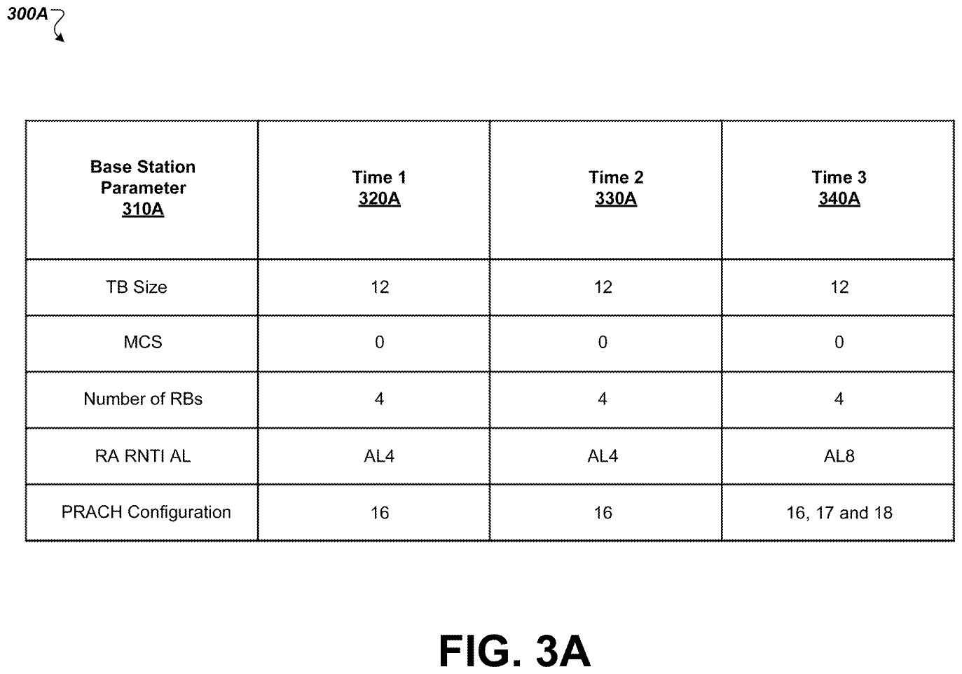

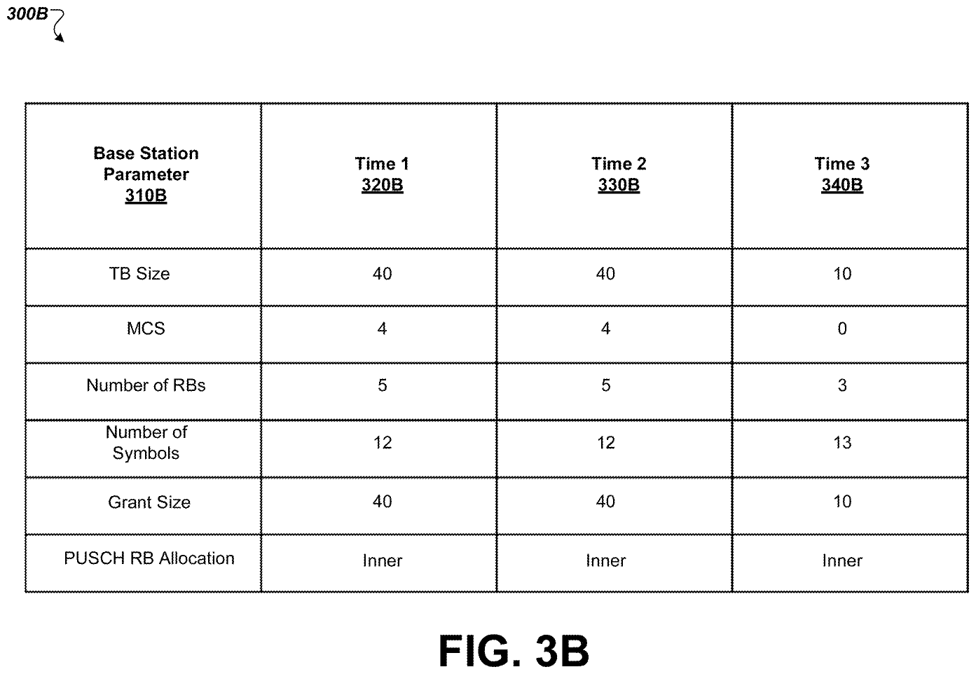

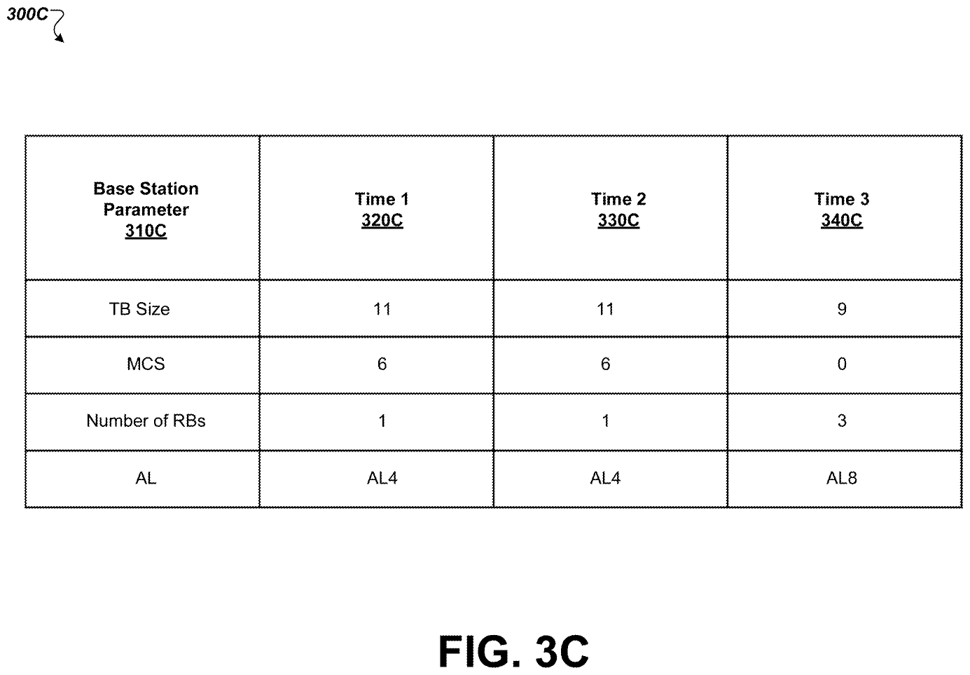

In some embodiments, a parameter is modified to a maximum value supported by the system 100. In some embodiments, a parameter is modified to a value based on supplemental parameters (e.g., supplemental counters). Examples of supplemental parameters include a number of preamble energy detections per PRACH occasion (MSG1), a peak number of useful preambles detected, signal strength (e.g., a received signal strength indicator (RSSI)), interference power, signal to noise ratio, timing advance (TA) distribution, a peg counter after the central unit-user plane (CU-UP) allocates RBs and delivers an RRC protocol setup to the UE 110, etc. Illustrative examples of modifying parameter(s) of a set of parameters across various messages of the RACH procedure will now be described below with reference to FIGS. 3A-3C.

FIGS. 3A-3C are tables 300A-300C illustrating examples of modifying RACH procedure parameters, according to some embodiments. In this illustrative example, it is assumed that the trigger event type that triggered the RACH procedure is a connection request. However, such as example should not be considered limiting, and the RACH procedure can be triggered by any suitable trigger event type in accordance with embodiments described herein (e.g., radio link failure, handover event, or UL data arrival).

For example, FIG. 3A is a table 300A illustrating an example of modifying at least one parameter corresponding to a RACH response message (MSG2) to be sent by the base station to UE during a RACH procedure. The modification to the at least one parameter shown in FIG. 3A can be performed based on a set of RACH procedure counters defined for RACH procedures triggered by connection requests (e.g., a set of RACH procedure counters defined for RACH response messages sent during RACH procedures triggered by connection requests).

The table 300A includes a column 310A identifying base station parameters (e.g., hardcoded parameters). For example, base station parameters can include TB size, MCS, number of RBs, RAN RNTI AL, and PRACH configuration, as described above. The table 300A further includes a column 320A identifying a value of a respective base station parameter during a first time (“Time 1”), a column 330A identifying a value of a respective base station parameter during a second time (“Time 2”), and a column 340A identifying a value of a respective base station parameter during a third time (“Time 3”). As shown in the table 300A, at Times 1 and 2, the TB size is 12, the MCS is 0, the number of RBs is 4, the RA RNTI AL is AL4, and the PRACH configuration is 16. More specifically, the PRACH configuration in this example is the time slot 16. At time 3, the TB size is 12, the MCS is 0, and the number of RBs is maintained at 4. However, the RA RNTI AL at Time 3 is modified to AL8, and the PRACH configuration is changed from time slot 16 to time slots 16, 17 and 18. The modification made to RA RNTI AL can improve decoding efficiency. The modification made to the PRACH configuration can reduce or eliminate Random Access Preamble Identifier (RAPID) mismatch failure.

As another example, FIG. 3B is a table 300B illustrating an example of modifying at least one parameter corresponding to an UL scheduled transmission message (e.g., MSG3) to be sent by the UE to the base station during the RACH procedure. The modification to the at least one parameter shown in FIG. 3B can be performed based on a set of RACH procedure counters defined for RACH procedures triggered by connection requests (e.g., a set of RACH procedure counters defined for UL scheduled transmission messages sent during RACH procedures triggered by connection requests).

The table 300B includes a column 310B identifying base station parameters (e.g., hardcoded parameters). For example, base station parameters can include TB size, MCS, number of RBs, number of symbols, grant size, and PUSCH RB allocation, as described above. The table 300B further includes a column 320B identifying a value of a respective base station parameter during a first time (“Time 1”), a column 330B identifying a value of a respective base station parameter during a second time (“Time 2”), and a column 340B identifying a value of a respective base station parameter during a third time (“Time 3”). As shown in the table 300B, at Times 1 and 2, the TB size is 40, the MCS is 4, the number of RBs is 5, the number of symbols is 12, the grant size is 40, and the PUSCH RB allocation is inner. At Time 3, the PUSCH RB allocation is inner. However, at Time 3, the TB size is modified to 10, the MCS is modified to 0, the number of RBs is reduced to 3, the number of symbols is increased to 3, and the grant size is decreased to 10. The modifications made to these parameters can increase energy efficiency, increase symbol efficiency, increase resource efficiency, reduce noise, and/or reduce padding bytes.

As yet another example, FIG. 3C is a table 300C illustrating an example of modifying at least one parameter corresponding to a contention resolution message (e.g., MSG4) to be sent by the base station to the UE during the RACH procedure. The modification to the at least one parameter shown in FIG. 3C can be performed based on a set of RACH procedure counters defined for RACH procedures triggered by connection requests (e.g., a set of RACH procedure counters defined for contention resolution messages sent during RACH procedures triggered by connection requests).

The table 300C includes a column 310C identifying base station parameters (e.g., hardcoded parameters). For example, base station parameters can include TB size, MCS, number of RBs, and AL as described above. The table 300C further includes a column 320C identifying a value of a respective base station parameter during a first time (“Time 1”), a column 330C identifying a value of a respective base station parameter during a second time (“Time 2”), and a column 340C identifying a value of a respective base station parameter during a third time (“Time 3”). As shown in the table 300C, at Times 1 and 2, the TB size is 11, the MCS is 6, the number of RBs is 1, and the AL is AL4. However, at Time 3, the TB size is decreased to 9, the MCS is modified to 0, the number of RBs is increased to 3, and the AL is modified to AL8. The modifications made to these parameters can increase resource efficiency, increase decoding efficiency, improve connection time, improve reliability and/or enhance UE user experience.

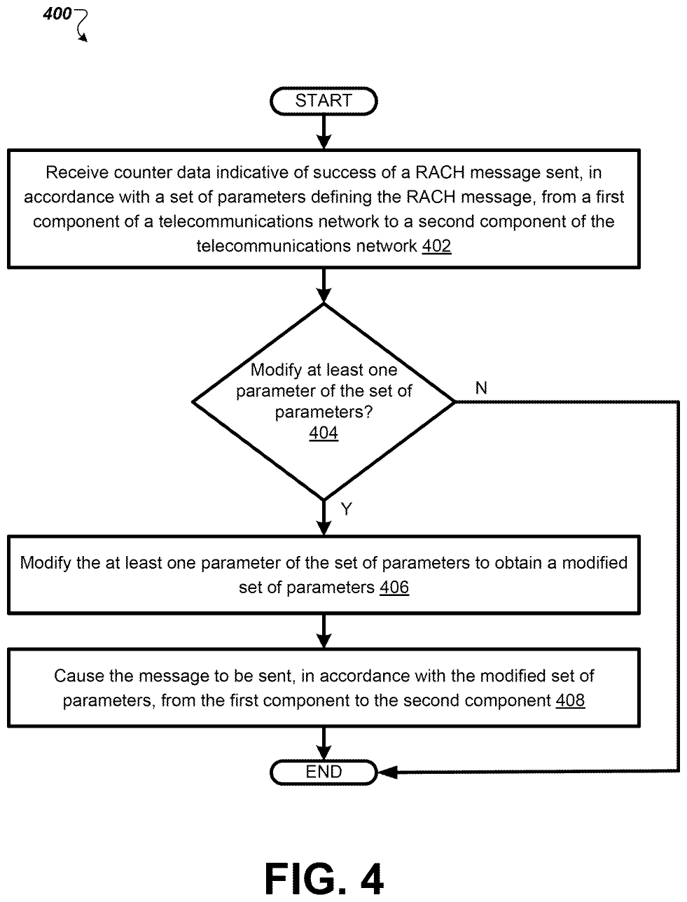

FIG. 4 is a flow diagram of a method 400 for improving RACH procedure success rates within a telecommunications network, according to certain embodiments. Method 400 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 400 may be performed, in part, by components of system 100. Method 400 may be performed by RPOS 140 of FIG. 1. In some embodiments, a non-transitory machine-readable storage medium stores instructions that when executed by a processing device (e.g., the RPOS 140 of FIG. 1) cause the processing device to perform method 400. For simplicity of explanation, method 400 is depicted and described as a series of operations. However, operations in accordance with this disclosure can occur in various orders and/or concurrently and with other operations not presented and described herein. Furthermore, not all illustrated operations may be performed to implement method 400 in accordance with the disclosed subject matter. In addition, those skilled in the art will understand and appreciate that method 400 could alternatively be represented as a series of interrelated states via a state diagram or events.

At operation 402, processing logic receives counter data indicative of success of a RACH message sent, in accordance with a set of parameters defining the RACH message, from a first component of a telecommunications network to a second component of the telecommunications network.

At operation 404, processing logic determines, based on the counter data, whether to modify at least one parameter of the set of parameters.

In some embodiments, the counter data and the set of parameters each correspond to a trigger event type that triggered the RACH procedure. Examples of trigger event types include connection request, radio link failure, handover event, UL data arrival, etc.

In some embodiments, the counter data is determined based on a trigger count indicative of a number of times that a RACH procedure was triggered by the trigger event type. In some embodiments, determining whether to modify the at least parameter based on the trigger count includes determining whether success of the RACH procedure determined from the trigger count fails to satisfy a threshold condition, and causing at least one parameter of the set of RACH procedure parameters to be modified in response to determining that the success of the RACH procedure determined from the trigger count fails to satisfy the threshold condition. In some embodiments, determining whether success of a RACH procedure determined from a trigger count fails to satisfy a threshold condition includes determining whether a success metric is less than or equal to a threshold success metric (or a failure metric is greater than or equal to a threshold failure metric).

If processing logic determines not to modify at least one parameter of the set of parameters at operation 404, then the process ends. At operation 406, if processing logic determines to modify at least one parameter of the set of parameters at operation 404, then processing logic modifies the at least one parameter of the set of parameters to obtain a modified set of parameters.

At operation 408, processing logic causes the message to be sent, in accordance with the modified set of parameters, from the first component to the second component.

In some embodiments, the message is a RACH request message (MSG1), the first component is UE, and the second component is a base station of a RAN.

In some embodiments, the message is a RACH response message (MSG2), the first component is a base station of a RAN, and the second component is UE. For example, modifying the at least one parameter can include modifying at least one of: TB size, an MCS value, a number of RBs, an RA RNTI AL, or a PRACH configuration.

In some embodiments, the message is an UL scheduled transmission message (MSG3), the first component is UE, and the second component is a base station of a RAN. For example, modifying the at least one parameter can include modifying at least one of: TB size, an MCS value, a number of RBs, a number of symbols, a grant size, or a PUSCH RB allocation.

In some embodiments, the message is a contention resolution message (MSG4), the first component is a base station of a RAN, and the second component is a UE. For example, modifying the at least one parameter can include modifying at least one of: TB size, an MCS value, a number of RBs, or an AL. Further details regarding operations 402-408 are described above with reference to FIGS. 1-4.

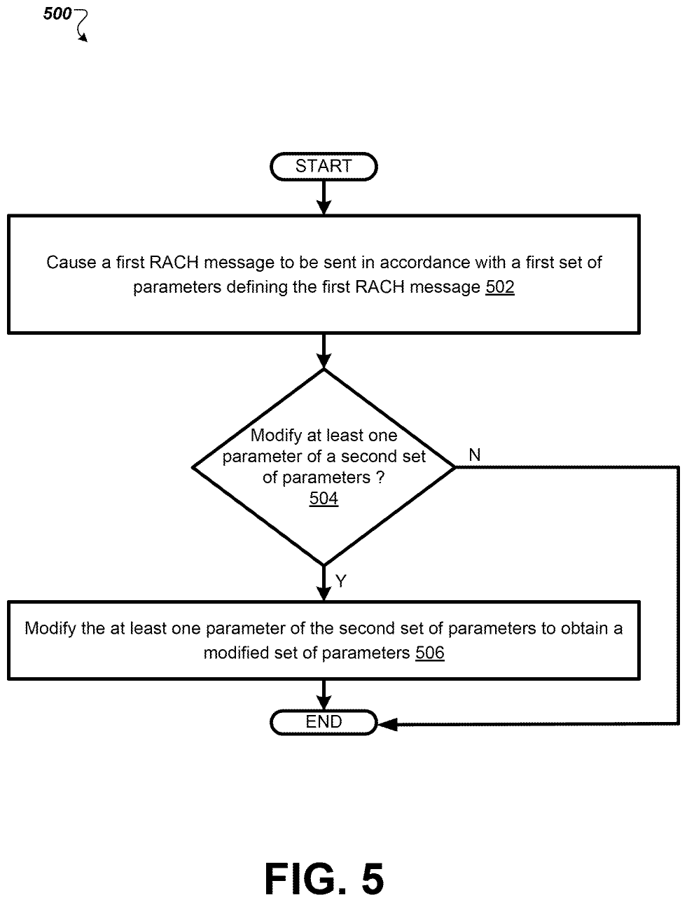

FIG. 5 is a flow diagram of a method 500 for improving RACH procedure success rates within a telecommunications network, according to certain embodiments. Method 500 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 500 may be performed, in part, by components of system 100. Method 500 may be performed by RPOS 140 of FIG. 1. In some embodiments, a non-transitory machine-readable storage medium stores instructions that when executed by a processing device (e.g., RPOS 140 of FIG. 1) cause the processing device to perform method 600. For simplicity of explanation, method 500 is depicted and described as a series of operations. However, operations in accordance with this disclosure can occur in various orders and/or concurrently and with other operations not presented and described herein. Furthermore, not all illustrated operations may be performed to implement method 500 in accordance with the disclosed subject matter. In addition, those skilled in the art will understand and appreciate that method 500 could alternatively be represented as a series of interrelated states via a state diagram or events.

At operation 502, processing logic causes a first RACH message to be sent in accordance with a first set of parameters defining the first RACH message. The first set of parameters were previously modified (e.g., similar to operation 406 of FIG. 4).

At operation 504, processing logic determines whether to modify at least one parameter of a second set of parameters. The second set of parameters defines a second RACH message, different from the first RACH message. Illustratively, if the first RACH message is a RACH request message (MSG1), then the second RACH message can be a RACH response message (MSG2).

If processing logic determines not to modify at least one parameter of a second set of parameters at operation 504, then the process ends. At operation 506, if processing logic determines to modify at least one parameter of a second set of parameters at operation 504, then processing logic modifies the at least one parameter of the second set of parameters to obtain a modified set of parameters.

Operations 502-504 can then be repeated to cause a second RACH message to be sent in accordance with the modified set of parameters defining the second RACH message, and to determine whether to modify at least one parameter of a third set of parameters different from the first set of parameters and the second set of parameters. The third set of parameters can define a third RACH message, different from the first RACH message and the second RACH message. Illustratively, if the first RACH message is a RACH request message (MSG1) and the second RACH message is a RACH response message (MSG2), then the third RACH message can be an UL schedule transmission message (MSG3). Further details regarding operations 502-506 are described above with reference to FIGS. 1-5.

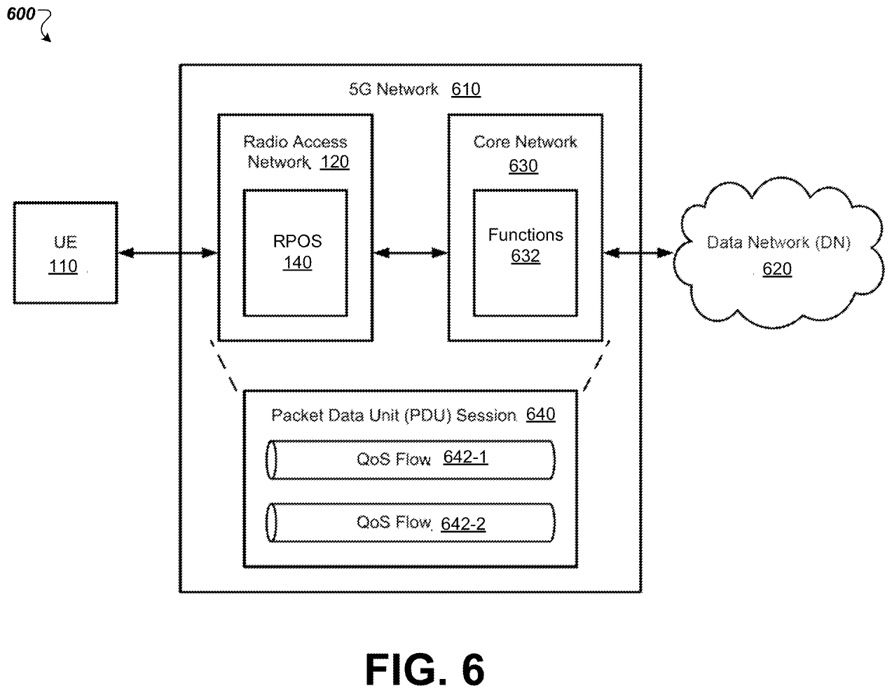

FIG. 6 depicts a 5G network 610 including the RAN 120 and a core network 630 according to at least one embodiment. The RAN 120 can be similar to the RAN 120 of FIG. 1. The RAN 120 can include a new-generation radio access network (NG-RAN) that uses the 5G new radio interface (NR). The 5G network 610 connects the UE 110 to a data network (DN) 620 using the RAN 120 and a core network 630. The DN 120 can include the Internet, a local area network (LAN), a wide area network (WAN), a private data network, a wireless network, a wired network, or a combination of networks. The UE 110 can include an electronic device with wireless connectivity or cellular communication capability, such as a mobile phone or handheld computing device. In at least one example, the UE 110 can include a 5G smartphone or a 5G cellular device that connects to the RAN 120 via a wireless connection.

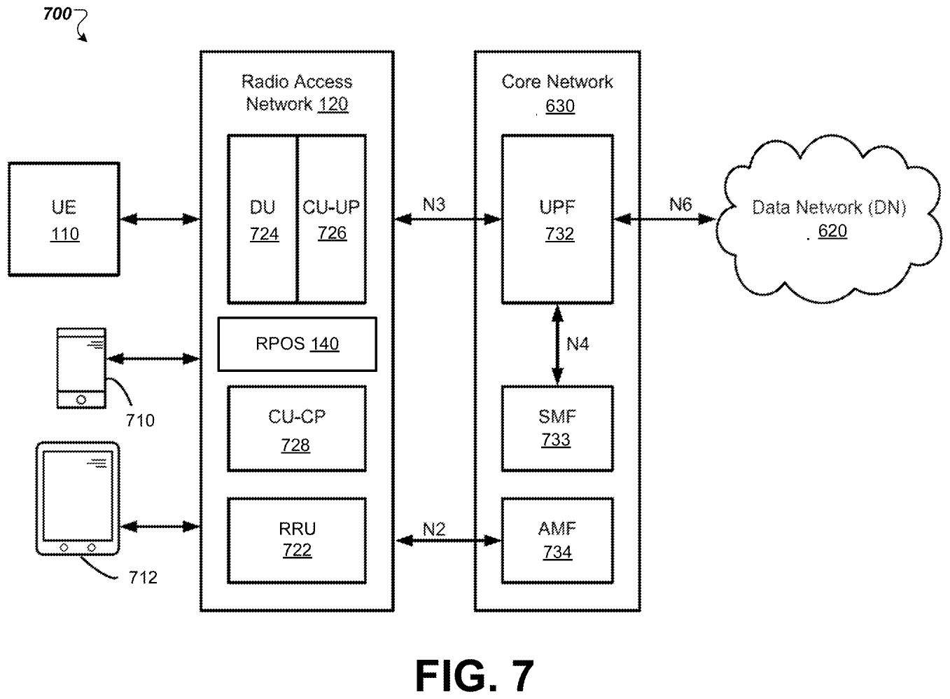

The RAN 120 may include at least one base station (e.g., the base station 125 of FIG. 1) that connects the UE 110 to the core network 630. In some embodiments, and as shown in FIG. 6, the RPOS 140 can be included in the RAN 120. As will be described in further detail below with reference to FIG. 7, the RAN 120 can include at least one remote radio unit (RRU) for wirelessly communicating with the UE 110. An RRU can include at least one radio unit (RU) and may include one or more radio transceivers for wirelessly communicating with UE 110. The at least one RRU may include circuitry for converting signals sent to and from an antenna of the base station into digital signals for transmission over packet networks.

The core network 630 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) and application programming interfaces (APIs). In at least one embodiment, an architecture in which software is composed of small independent services that communicate over well-defined APIs may be used for implementing some of the core network functions. For example, control plane (CP) network functions for performing session management may be implemented as containerized applications. A container-based embodiment may offer improved scalability and availability over other approaches.

Core network functions (“functions”) 632 of core network can include an access and mobility management function (AMF), a session management function (SMF), and a user plane function (UPF). In at least one embodiment, the intelligent data collector can be implemented in the AMF. The UPF may perform packet processing including routing and forwarding, quality of service (QOS) handling, and packet data unit (PDU) session management. The UPF may serve as an ingress and egress point for user plane traffic and provide anchored mobility support for user equipment. For example, the UPF may provide an anchor point between the UE 110 and the DN 620 as the UE 110 moves between coverage areas. The AMF may act as a single-entry point for UE connection and perform mobility management, registration management, and connection management between a data network and the UE 110. The SMF may perform session management, user plane selection, and internet protocol (IP) address allocation. Functions 632 can include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment. Further details regarding the functions 632 will be described below with reference to FIG. 7.

The 5G network 610 may provide one or more network slices, where each network slice may include a set of network functions that are selected to provide telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 610. In some cases, the 5G network 610 may support customized policy configuration and enforcement between network slices per service level agreements (SLAs) within the radio access network (RAN) 120. User equipment, such as UE 110, may connect to multiple network slices at the same time (e.g., eight different network slices). In one embodiment, a PDU session, such as PDU session 640, may belong to only one network slice instance.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 120, such as a distributed unit (DU) and a centralized unit (CU), may need to be deployed at a base station or in a local data center (LDC) that is in close proximity to a base station such that the latency requirements are satisfied (e.g., such that the one-way latency from the base station to the DU component or CU component is less than 1.2 milliseconds (ms)). In some embodiments, the DU and the CU of the RAN 120 may be co-located with the RRU. In other embodiments, the DU and the RRU may be co-located at a base station and the CU may be located within a local data center (LDC).

In some cases, the 5G network 610 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 630 may include a set of network elements that are configured to offer various data and telecommunications services to subscribers or end users of user equipment, such as UE 110. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software embodiment of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 610 may implement various network functions, such as the functions 632 and radio access network functions, using a cloud-based compute and storage infrastructure. A network function may be implemented as a software instance running on hardware or as a virtualized network function. Virtual network functions (VNFs) can include embodiments of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 5G network 610 may connect the UE 110 to the data network 620 using a PDU session 640, which can include part of an overlay network. The PDU session 640 may utilize one or more quality of service (QOS) flows, such as QoS flows 605 and 606, to exchange traffic (e.g., data and voice traffic) between the UE 110 and the data network 620. The one or more QoS flows can include the finest granularity of QoS differentiation within the PDU session 640. The PDU session 640 may belong to a network slice instance through the 5G network 610. To establish user plane connectivity from the UE 110 to the data network 620, an AMF that supports the network slice instance may be selected and a PDU session via the network slice instance may be established. In some cases, the PDU session 640 may be of type IPv4 or IPv6 for transporting IP packets. The RAN 120 may be configured to establish and release parts of the PDU session 640 that cross the radio interface.

The RAN 120 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 110, over a geographic area. Some cells may correspond with stationary coverage areas and other cells may correspond with coverage areas that change over time (e.g., due to movement of a mobile RRU). In some cases, the UE 110 may be capable of transmitting signals to and receiving signals from one or more RRUs within the network of cells over time. One or more cells may correspond with a base station. The cells within the network of cells may be configured to facilitate communication between UE 110 and other UEs and/or between UE 110 and a data network, such as data network 620. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mm Wave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The UPF may be responsible for routing and forwarding user plane packets between the RAN 120 and the data network 620. Uplink packets arriving from the RAN 120 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 120 and the UPF.

The UPF may remove the packet headers belonging to the GTP tunnel before forwarding the user plane packets towards the data network 620. As the UPF may provide connectivity towards other data networks in addition to the data network 620, the UPF must ensure that the user plane packets are forwarded towards the correct data network. Each GTP tunnel may belong to the PDU session 640. The PDU session 640 may be set up towards a data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network 620 are mapped onto at least one quality of service (QOS) flow belonging to the PDU session 640 before forwarded towards the appropriate RAN 120. A QOS flow may correspond with a stream of data packets that have equal QoS. In some embodiments, and as shown in FIG. 6, multiple QoS flows including QoS flow 642-1 and 642-2 can belong to the PDU session 640. The UPF may use a set of service data flow (SDF) templates to map each downlink packet onto a respective QoS flow. The UPF may receive the set of SDF templates from a session management function (SMF), such as the SMF, during setup of the PDU session 640. The SMF may generate the set of SDF templates using information provided from a policy control function (PCF), such as the PCF. The UPF may track various statistics regarding the volume of data transferred by each PDU session, such as PDU session 640, and provide the information to an SMF.

FIG. 7 depicts a RAN 120 and a core network 630 for providing a communications channel (or channel) between user equipment and data network 620 according to at least one embodiment. In at least one embodiment, the RPOS 140 can be implemented in the RAN 120. The communications channel can include a pathway through which data is communicated between the UE 110 and the data network 620. The UE in communication with the RAN 120 includes UE 110, mobile phone 710, and mobile computing device 712. The UE may include a set of electronic devices, including mobile computing device and non-mobile computing device.

The core network 630 includes core network functions such as UPF 732, SMF 733 and AMF 734, as described above with reference to FIG. 6. For example, the AMF 734 may interface with user equipment and act as a single-entry point for a UE connection. The AMF 734 may interface with the SMF to track user sessions. The AMF 734 may interface with a network slice selection function (NSSF) not depicted to select network slice instances for user equipment, such as UE 110. When user equipment is leaving a first coverage area and entering a second coverage area, the AMF 734 may be responsible for coordinating the handoff between the coverage areas whether the coverage areas are associated with the same radio access network or different radio access networks.

The UPF 732 may transfer downlink data received from the data network 620 to user equipment, such as UE 110, via the RAN 120 and/or transfer uplink data received from user equipment to the data network 620 via the RAN 120. An uplink can include a radio link though which user equipment transmits data and/or control signals to the RAN 120. A downlink can include a radio link through which the RAN 120 transmits data and/or control signals to the user equipment.

The RAN 120 may be logically divided into an RRU 722, a DU 724, and a CU that is partitioned into a CU user plane portion (CU-UP) 726 and a CU control plane portion (CU-CP) 728. The CU-UP 726 may correspond with the centralized unit for the user plane and the CU-CP 728 may correspond with the centralized unit for the control plane. The CU-CP 728 may perform functions related to a control plane, such as connection setup, mobility, and security. The CU-UP 726 may perform functions related to a user plane, such as user data transmission and reception functions.

Decoupling control signaling in the control plane from user plane traffic in the user plane may allow the UPF 732 to be positioned in close proximity to the edge of a network compared with the AMF 734. In at least one embodiment, the intelligent data collector 106 can be implemented in the AMF 734. As a closer geographic or topographic proximity may reduce the electrical distance, this means that the electrical distance from the UPF 732 to the UE 110 may be less than the electrical distance of the AMF 734 to the UE 110. The RAN 120 may be connected to the AMF 734, which may allocate temporary unique identifiers, determine tracking areas, and select appropriate policy control functions (PCFs) for user equipment, via an N2 interface. The N3 Interface may be used for transferring user data (e.g., user plane traffic) from the RAN 120 to the user plane function UPF 732 and may be used for providing low-latency services using edge computing resources. The electrical distance from the UPF 732 (e.g., located at the edge of a network) to user equipment, such as UE 110, may impact the latency and performance services provided to the user equipment. The UE 110 may be connected to the SMF 733 via an N1 interface not depicted, which may transfer UE information directly to the AMF 734. The UPF 732 may be connected to the data network 620 via an N6 interface. The N6 interface may be used for providing connectivity between the UPF 732 and other external or internal data networks (e.g., to the Internet). The RAN 120 may be connected to the SMF 733, which may manage UE context and network handovers between Base Stations, via the N2 interface. The N2 interface may be used for transferring control plane signaling between the RAN 120 and the AMF 734.

The RRU 722 may perform physical layer functions, such as employing orthogonal frequency-division multiplexing (OFDM) for downlink data transmission. In some cases, the DU 724 may be located at a base station (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different base stations and 180 different RRUs.

In some embodiments, the RAN 120 or portions of the RAN 120 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 724 and CU-UP 726 may be executed as virtual instances within a data center environment that provides single-digit millisecond latencies (e.g., less than 2 ms) from the virtual instances to the UE 110.

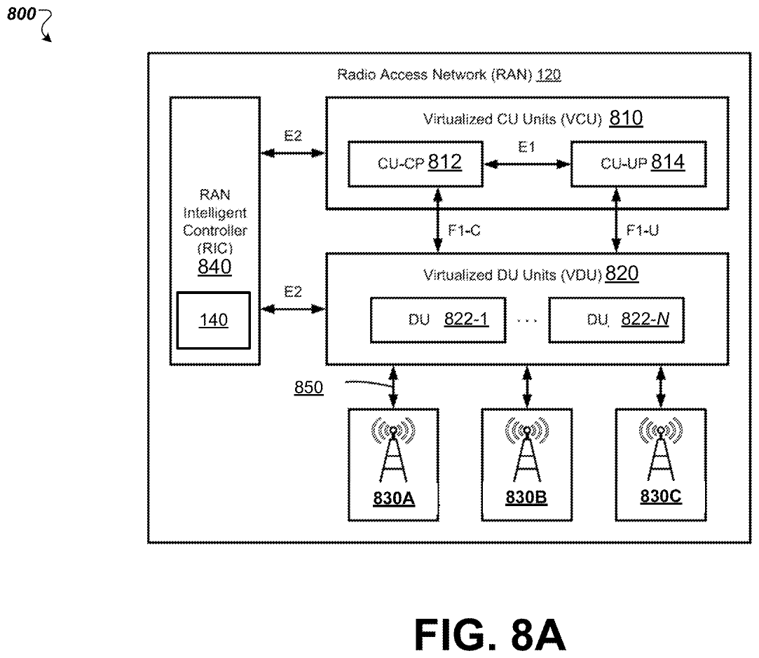

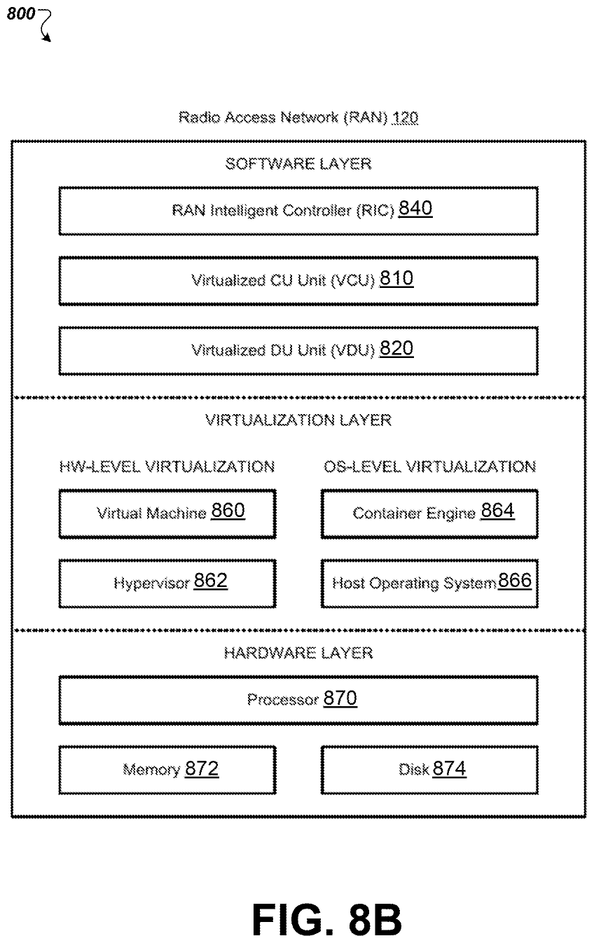

FIG. 8A depicts an example RAN 120, according to at least one embodiment. The RAN 120 includes virtualized CU units (VCU) 810, virtualized DU units (VDU) 820, remote radio units (RRUs) 830A-830C, and a RAN intelligent controller (RIC) 840.

The virtualized CU units 810 can include virtualized versions of centralized units (CUs), including a centralized unit for the control plane (CU-CP) 812 and a centralized unit for the user plane (CU-UP) 814. In one example, CUs can include a logical node configured to provide functions for the radio resource control (RRC) layer, the packet data convergence control (PDCP) layer, and the service data adaptation protocol (SDAP) layer. The CU-CP 812 can include a logical node configured to provide functions of the control plane part of the RRC and PDCP. The CU-UP 814 can include a logical node configured to provide functions of the user plane part of the SDAP and PDCP. Virtualizing the control plane and user plane functions allows the CUs to be consolidated in one or more data centers on RAN-based open interfaces.

The virtualized DU units 820 can include virtualized versions of DUs 822-1 through 822-N. Each DU 822-1 through 822-N can include a logical node configured to provide functions for the radio link control (RLC) layer, the medium access control (MAC) layer, and the physical layer (PHY) layers.

In some embodiments, and as shown in FIG. 8, the RPOS 140 can be implemented in the RIC 840 to improve RACH procedure success, as described herein. In some embodiments, the intelligent data collector 106 can be implemented in the VCU 810 to improve RACH procedure success, as described herein.

The RRUs 830A-830C may correspond with different base stations. A single DU may connect to multiple RRUs via a fronthaul interface 850. The fronthaul interface 850 may provide connectivity between DUs and RRUs. For example, DU 830A may connect to 18 RRUs via the fronthaul interface 850. CUs may control the operation of multiple DUs via a midhaul F1 Interface that includes the F1-C and F1-U interfaces. The F1 Interface may support control plane and user plane separation, and separate the Radio Network Layer and the Transport Network Layer. In one example, the CU-CP 812 may connect to ten different DUs within the virtualized DU units 1210. In this case, the CU-CP 812 may control ten DUs and 180 RRUs. A single one of DUs 822-1 through 822-N may be located at a base station or in a local data center. Centralizing a single DU at a local data center or at a single base station location instead of distributing the single DU 1204 across multiple base stations may result in reduced costs.

The CU-CP 812 may host the radio resource control (RRC) layer and the control plane part of the packet data convergence control (PDCP) layer. The E1 Interface may separate the Radio Network Layer and the Transport Network Layer. The CU-CP 812 terminates the E1 Interface connected with the centralized unit for the user plane CU-UP 814 and the F1-C interface connected with the DUs 822-1 through 822-N. The CU-UP 814 hosts the user plane part of the PDCP layer and a service data adaptation protocol (SDAP) layer. The CU-UP 814 terminates the E1 Interface connected with the centralized unit for the control plane CU-CP 812 and the F1-U interface connected with the DUs 822-1 through 822-N. The DUs 822-1 through 822-N may handle the lower layers of the baseband processing up through the PDCP layer of the protocol stack. The interfaces F1-C and E1 may carry signaling information for setting up, modifying, relocating, and/or releasing a UE context.

The RIC 840 may control the underlying RAN elements via the E2 Interface. The E2 Interface connects the RIC 840 to the DUs 822-1 through 822-N and the centralized units including CU-CP 812 and CU-UP 814. The RIC 840 can include a real time or near-real time RIC (RT-RIC) or a non-real-time RIC (NRT-RIC). An NRT-RIC can include a logical node allowing non-real time control rather than near-real-time control and an RT-RIC can include a logical node allowing near-real-time control and optimization of RAN elements and resources on the bases of information collected from the DUs 822-1 through 822-N and the centralized units including CU-CP 812 and CU-UP 814 via the E2 Interface.

The virtualization of the DUs 822-1 through 822-N and the centralized units including CU-CP 812 and CU-UP 814 allows various deployment options that may be adjusted over time based on network conditions and network slice requirements. In at least one example, both a DU and a corresponding centralized unit may be implemented at a base station. In another example, at least one DUs 822-1 through 822-N may be implemented at a base station and the corresponding CU-UP 814 may be implemented at a local data center (LDC). In another example, at least one DUs 822-1 through 822-N and the corresponding CU-UP 814 may be implemented at an LDC. In another example, at least one DUs 822-1 through 822-N and a corresponding CU-UP 814 may be implemented at a base station, but the corresponding the centralized unit CU-CP 812 may be implemented at an LDC. In another example, at least one DUs 822-1 through 822-N may be implemented at an LDC and the corresponding CU-CP 812 and CU-UP 814 may be implemented at an EDC.

In some embodiments, network slicing operations may be communicated via the E1, F1-C, and F1-U interfaces of the RAN 120. For example, CU-CP 812 may select the appropriate DU and CU-UP 814 entities to serve a network slicing request associated with a particular service level agreement (SLA).

FIG. 8B depicts a RAN 120 according to at least one embodiment. As depicted, the RAN 120 a software layer, a virtualization layer and a hardware layer. The software layer can include software applications, such as RIC 840, VCU 810, and VDU 820.

The virtualization layer can include at least one virtual machine 860, a hypervisor 862, container engine 864, and a host operating system 866. The hypervisor 862 can include a native hypervisor (or bare-metal hypervisor) or a hosted hypervisor (or type 2 hypervisor). The hypervisor 862 may provide a virtual operating platform for running at least one virtual machine 860. The hypervisor 862 can include software that creates and runs virtual machine instances. The at least one virtual machine 860 may include a set of virtual hardware devices, such as a virtual processor, a virtual memory, and a virtual disk. The at least one virtual machine 860 may include a guest operating system that has the capability to run one or more software applications, such as the RIC 840. The at least one virtual machine 860 may run the host operating system 866 upon which the container engine 864 may run. At least one virtual machine 860 may include one or more virtual processors. The container engine 864 may run on top of the host operating system 866 in order to run multiple isolated instances (or containers) on the same operating system kernel of the host operating system 866. Containers may perform virtualization at the operating system level and may provide a virtualized environment for running applications and their dependencies. The container engine 864 may acquire a container image and convert the container image into running processes. In some cases, the container engine 864 may group containers that make up an application into logical units (or pods). A pod may contain one or more containers and all containers in a pod may run on the same node in a cluster. Each pod may serve as a deployment unit for the cluster. Each pod may run a single instance of an application.

In order to scale an application horizontally, multiple instances of a pod may be run in parallel. A “replica” may refer to a unit of replication employed by a computing platform to provision or deprovision resources. Some computing platforms may run containers directly and therefore a container can include the unit of replication. Other computing platforms may wrap one or more containers into a pod and therefore a pod can include the unit of replication.

A replication controller may be used to ensure that a specified number of replicas of a pod are running at the same time. If less than the specified number of pods are running (e.g., due to a node failure or pod termination), then the replication controller may automatically replace a failed pod with a new pod. In some cases, the number of replicas may be dynamically adjusted based on a prior number of node failures. For example, if it is detected that a prior number of node failures for nodes in a cluster running a particular network slice has exceeded a threshold number of node failures, then the specified number of replicas may be increased (e.g., increased by one). Running multiple pod instances and keeping the specified number of replicas constant may prevent users from losing access to their application in the event that a particular pod fails or becomes inaccessible.

In some embodiments, a virtualized infrastructure manager not depicted may run on the RAN 120 in order to provide a centralized platform for managing a virtualized infrastructure for deploying various components of the RAN 120. The virtualized infrastructure manager may manage the provisioning of virtual machines, containers, and pods. The virtualized infrastructure manager may also manage a replication controller responsible for managing a number of pods. In some cases, the virtualized infrastructure manager may perform various virtualized infrastructure related tasks, such as cloning virtual machines, creating new virtual machines, monitoring the state of virtual machines, and facilitating backups of virtual machines.

The hardware-level components include at least one processor 870, at least one memory 872 operatively coupled with the at least one processor 870, and at least one disk 874. The at least one memory 872 can have stored therein processor-readable instructions when, when executed by the at least one processor 870, causes the at least one processor 870 to perform operations described herein. The components of the software layer may be run using the components of the hardware layer or executed using processor and storage components of the hardware layer. In some examples, at least one of the RIC 840, VCU 810, or VDU 820 may be run using the at least one processor 870, the at least one memory 872, and the at least one disk 874. In another example, at least one of the RIC 840, VCU 810, or VDU 820 may be run using a virtual processor and a virtual memory that are themselves executed or generated using the at least one processor 870, the at least one memory 872, and the at least one disk 874.

The at least one processor 870 may include one or more processing units, such as one or more CPUs and/or one or more graphics processing units (GPUs). The at least one memory 872 can include one or more types of memory (e.g., random-access memory (RAM), static RAM (SRAM), dynamic RAM (DRAM), read-only memory (ROM), electrically erasable programmable read-only memory (EEPROM), or flash memory). The at least one disk 874 can include a hard disk drive and/or a solid-state drive.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving counter data indicative of success of a random access channel (RACH) message of a RACH procedure sent, in accordance with a set of parameters defining the RACH message, from a first component of a telecommunications network to a second component of the telecommunications network;
determining, based on the counter data, whether to modify at least one parameter of the set of parameters;
in response to determining to modify the at least one parameter based on the counter data, modifying the at least one parameter to obtain a modified set of parameters; and
causing the message to be sent, in accordance with the modified set of parameters, from the first component to the second component.

2. The method of claim 1, wherein the counter data and the set of parameters each correspond to a trigger event type that triggered the RACH procedure.

3. The method of claim 2, wherein the counter data is determined based on a trigger count indicative of a number of times that a RACH procedure was triggered by the trigger event type.

4. The method of claim 1, wherein the message is a RACH request message, wherein the first component is user equipment (UE), and wherein the second component is a base station of a radio access network (RAN).

5. The method of claim 4, wherein modifying the at least one parameter comprises modifying at least one of: frequency start, physical RACH (PRACH) location, PRACH transmit power, or PRACH configuration.

6. The method of claim 1, wherein the message is a RACH response message, wherein the first component is a base station of a radio access network (RAN), and wherein the second component is user equipment (UE).

7. The method of claim 6, wherein modifying the at least one parameter comprises modifying at least one of: transport block (TB) size, a modulation and coding scheme (MCS) value, a number of resource blocks (RBs), a random access-radio network temporary identifier aggregation level (RA RNTI AL), or a physical RACH (PRACH) configuration.

8. The method of claim 1, wherein the message is an uplink (UL) scheduled transmission message, wherein the first component is user equipment, and wherein the second component is a base station of a radio access network (RAN).

9. The method of claim 8, wherein modifying the at least one parameter comprises modifying at least one of: transport block (TB) size, a modulation and coding scheme (MCS) value, a number of resource blocks (RBs), a number of symbols, a grant size, or a physical uplink shared channel (PUSCH) RB allocation.

10. The method of claim 1, wherein the message is a contention resolution message, wherein the first component is a base station of a radio access network (RAN), and wherein the second component is user equipment (UE).

11. The method of claim 10, wherein modifying the at least one parameter comprises modifying at least one of: transport block (TB) size, a modulation and coding scheme (MCS) value, a number of resource blocks (RBs), or an aggregation level (AL).

12. A system comprising:
a memory; and
a processing device, operatively coupled with the memory, to:
receive counter data indicative of success of a random access channel (RACH) message of a RACH procedure sent, in accordance with a set of parameters defining the RACH message, from a first component of a telecommunications network to a second component of the telecommunications network;
determine, based on the counter data, whether to modify at least one parameter of the set of parameters;
in response to determining to modify the at least one parameter based on the counter data, modify the at least one parameter to obtain a modified set of parameters; and
cause the message to be sent, in accordance with the modified set of parameters, from the first component to the second component.

13. The system of claim 12, wherein the counter data and the set of parameters each correspond to a trigger event type that triggered the RACH procedure.

14. The system of claim 13, wherein the counter data is determined based on a trigger count indicative of a number of times that a RACH procedure was triggered by the trigger event type.

15. The system of claim 12, wherein the message is a RACH request message, wherein the first component is user equipment (UE), wherein the second component is a base station of a radio access network (RAN), and wherein modifying the at least one parameter comprises modifying at least one of: frequency start, physical RACH (PRACH) location, PRACH transmit power, or PRACH configuration.

16. The system of claim 12, wherein the message is a RACH response message, wherein the first component is a base station of a radio access network (RAN), wherein the second component is user equipment (UE), and wherein modifying the at least one parameter comprises modifying at least one of: transport block (TB) size, a modulation and coding scheme (MCS) value, a number of resource blocks (RBs), a random access-radio network temporary identifier aggregation level (RA RNTI AL), or a physical RACH (PRACH) configuration.

17. The system of claim 12, wherein the message is an uplink (UL) scheduled transmission message, wherein the first component is user equipment, wherein the second component is a base station of a radio access network (RAN), and wherein modifying the at least one parameter comprises modifying at least one of: transport block (TB) size, a modulation and coding scheme (MCS) value, a number of resource blocks (RBs), a number of symbols, a grant size, or a physical uplink shared channel (PUSCH) RB allocation.

18. The system of claim 12, wherein the message is a contention resolution message, wherein the first component is a base station of a radio access network (RAN), wherein the second component is user equipment (UE), and wherein modifying the at least one parameter comprises modifying at least one of: transport block (TB) size, a modulation and coding scheme (MCS) value, a number of RBs, or an aggregation level (AL).

19. One or more non-transitory, computer-readable storage media having computer-readable instructions thereon which, when executed by one or more processing devices, cause the one or more processing devices to perform operations comprising:
receiving counter data indicative of success of a random access channel (RACH) message of a RACH procedure sent, in accordance with a set of parameters defining the RACH message, from a first component of a telecommunications network to a second component of the telecommunications network;
determining, based on the counter data, whether to modify at least one parameter of the set of parameters;
in response to determining to modify the at least one parameter based on the counter data, modifying the at least one parameter to obtain a modified set of parameters; and
causing the message to be sent, in accordance with the modified set of parameters, from the first component to the second component.

20. The one or more non-transitory, computer-readable storage media of claim 19, wherein the counter data and the set of parameters each correspond to a trigger event type that triggered the RACH procedure, and wherein the counter data is determined based on a trigger count indicative of a number of times that a RACH procedure was triggered by the trigger event type.
